(19) United States
(12) Patent Application Publication
(10) Pub. No.: US 2023/0320514 A1
(43) Pub. Date: Oct. 12, 2023

(54) VACUUM-INSULATED COOKING DEVICE

(71) Applicant: In O HAN, Hwaseong-si Gyeonggi-do (KR)

(72) Inventor: In O HAN, Hwaseong-si Gyeonggi-do (KR)

(21) Appl. No.: 18/025,366

(22) PCT Filed: Nov. 30, 2020
(86) PCT No.: PCT/KR2020/017219

§ 371 Date: Mar. 8, 2023

(30) Foreign Application Priority Data
Sep. 9, 2020 (KR) 10-2020-0115595

(51) Int. Cl. A47J 27/05; A47J 41/02; A47J 27/084; A47J 27/00

(52) U.S. Cl. CPC A47J 27/05; A47J 27/002; A47J 27/084; A47J 41/028

(57) ABSTRACT

A vacuum-insulated cooking device comprises: a vacuum-insulated body including a bottom plate and a sidewall extending from an edge of the bottom plate to one side, wherein the bottom plate and the sidewall are vacuum-insulated by a vacuum pressure lower than atmospheric pressure; a shelf which is accommodated in a storage space formed by the bottom plate and the side wall and on which stones and food materials heated to a high temperature from the outside are stored layer by layer; and a lid, having the same shape as an opening of the vacuum-insulated body, for opening and closing of the opening.

### CROSS-REFERENCE TO RELATED APPLICATIONS

This application claims the benefit of priority of PCT App. Ser. No. PCT/KR2020/017219, filed Nov. 30, 2020, which in turn claims the benefit of priority of Korean Pat. App. Ser. No. 10-2020-0115595, the contents of which are incorporated by reference herein in their entirety.

### STATEMENT REGARDING FEDERALLY SPONSORED RESEARCH OR DEVELOPMENT

The invention described herein was made without the benefit of federal funding.

### BACKGROUND OF THE INVENTION

The present invention relates to a vacuum-insulated cooking device, and in particular, relates to a vacuum-insulated cooking device in which stones heated to a high temperature and food materials to be processed are put together into a vacuum-insulated container to cook food with indirect heat, which is safe and prevents food from burning and can keep warm at a constant temperature.

In recent years, as food culture has become westernized, the technology development of barbecue and barbecue equipment for grilling meat on direct fire is rapidly progressing.

Barbecue equipment heats and cooks meat using charcoal or firewood and the like, or using gas or electric energy.

Meat cooked by barbecue equipment has the advantage of intense taste and flavor since it is mainly cooked by direct fire, but it is not easy to cook uniformly, such as burning the surface of the meat, there is a risk of burns, and there is a problem in that processing after cooking is cumbersome.

In Japanese Pat. No. 2007-049974, ‘High Temperature and High Pressure Stone Bulgogi Cooking (HORHOG) New recipe’ (published on Mar. 1, 2007), a new recipe for cooking has been disclosed, in which cooking is performed by putting heated stones and meat into a pressure pot while roasting the meat in a stone and steaming at high temperature and high pressure, at home and restaurants.

However, in the case of the above, a technology of simply putting stones and meat into a pressure pot and heating them has been disclosed, but since the container is directly heated by fire, the risk of safety accidents is high, and especially since stones and meat are mixed together in the container, separation of the meat from the stones after cooking is difficult, and there is a risk of burns due to the high-temperature stones in this process, and because the pressure container is heated directly, it has a problem such as burning or undercooking of the meat that makes uniform cooking difficult.

### BRIEF DESCRIPTION OF THE DRAWINGS

FIG. 1 is an external perspective view of a vacuum-insulated cooking device according to an embodiment of the present invention.

FIG. 2 is an exploded perspective view of a vacuum-insulated cooking device according to an embodiment of the present invention.

FIG. 3 is a cross-sectional view taken along the line I-I′ of FIG. 1.

FIG. 4 is a cross-sectional view of a vacuum-insulated cooking device according to another embodiment of the present invention.

FIG. 5 is an enlarged view of part ‘A’ of FIG. 4.

FIG. 6 is a cross-sectional view illustrating a shelf according to another embodiment of the present invention.

FIG. 7 is a front view seen from the ‘B’ direction of FIG. 6.

FIG. 8 is a cross-sectional view illustrating a metal storage container mounted on a shelf according to yet another embodiment of the present invention.

FIG. 9 is a perspective view illustrating a shelf according to yet another embodiment of the present invention.

FIG. 10 is an enlarged view of part ‘C’ of FIG. 9.

FIG. 11 is a perspective view illustrating a shelf according to yet another embodiment of the present invention.

FIG. 12 is a cross-sectional view of a vacuum-insulated cooking device according to another embodiment of the present invention.

FIG. 13 is a view illustrating a shelf according to another embodiment used in a vacuum-insulated cooking device according to another embodiment of the present invention.

FIG. 14 is a view illustrating a shelf according to another embodiment used in a vacuum-insulated cooking device according to another embodiment of the present invention.

FIG. 15 is a perspective view illustrating a vacuum-insulated cooking device according to yet another embodiment of the present invention.

FIG. 16 is a cross-sectional view illustrating a vacuum-insulated cooking device according to yet another embodiment of the present invention.

### DETAILED DESCRIPTION OF THE INVENTION

The present invention reduces the risk of burns since there is no direct use of heat to cook food, and it is a simple cooking method using indirect heat of pre-heated stones and a vacuum-insulated container and provides a vacuum-insulated cooking device that can prevent uneven cooking such as burning or undercooking of meat.

As an embodiment, it comprises: a vacuum-insulated body including a bottom plate and a sidewall extending from an edge of the bottom plate to one side, wherein the bottom plate and the sidewall are vacuum-insulated by a vacuum pressure lower than the atmospheric pressure; a shelf which is accommodated in a storage space formed by the bottom plate and the side wall and on which stones and food materials heated to a high temperature from the outside are stored layer by layer; and a lid, having the same shape as an opening of the vacuum-insulated body, for opening and closing of the opening.

An alignment groove is formed on an inner side surface of a side wall of the vacuum-insulated body to align the shelf to a designated position in a direction directing from an upper end to a lower end of the side wall; a lower surface of the shelf is formed at a lower end of the side wall; and a step separating the lower surface of the shelf from an inner side surface of the bottom plate is formed at a lower end of the side wall.

The lid is made of a metal material, a vacuum pressure lower than the atmospheric pressure is formed inside, and a handle is formed on an upper surface thereof.

The lid comprises: a first lid formed of a wooden material and formed in a shape being coupled to the opening; and a second lid made of metal and coupled to an inner side surface of the first lid, being fit-coupled into the side wall, and being formed concavely in a middle portion, wherein a plurality of rings are formed at equal intervals on an outer side surface of the second lid, and wherein hooks being detachably coupled to each of the rings are formed in the shelf.

A handle is formed in the first lid, and a discharge outlet for discharging steam generated inside the vacuum-insulated body is formed at a portion of the second lid being in contact with the side wall.

The shelf comprises: a lower shelf being formed to have a size being inserted into the vacuum-insulated body and having a plurality of horizontal bars; an upper shelf being spaced upward from the lower shelf and having the horizontal bars formed therein; a middle shelf, at least one is disposed between the upper shelf and the lower shelf, and formed with the horizontal bars therein; a vertical bar interconnecting the upper shelf, the middle shelf and the lower shelf; and a hook extending from the vertical bar to an upper portion of the upper shelf, wherein the lower shelf and the upper shelf are disposed parallel to each other, and wherein the middle shelf is inclinedly disposed with respect to the lower shelf.

The lower shelf, the upper shelf, and the middle shelf are formed in a circular shape; a wire mesh is formed on a portion of a side surface of the shelf to prevent stones or food materials from falling from the lower shelf, the upper shelf, and the middle shelf; and the direction of the horizontal bar is formed to be parallel to the opening direction of the wire mesh.

A metal storage container capable of storing stones or food is detachably coupled between the lower shelf and the middle shelf, and between the middle shelf and the upper shelf, respectively.

A pivoting member having a pipe shape is coupled to a side surface of the metal storage container, and the pivoting member is pivotally coupled to the vertical bar.

An end portion of the vertical bar is extended to the outside of the lid, and an escape hole is formed in the lid to allow the vertical bar to pass through.

The shelf comprises: a first stone storage shelf that stores stones in a disc shape and being heated; a second stone storage shelf that is formed in a cylindrical shape at a central portion of the first stone storage shelf and stores stones being heated; a food storage shelf in which food is stored by being inserted into a bar extending horizontally from an upper end of the second stone storage shelf and being disposed in an erected state around the second stone storage shelf; and a handle formed on an outer side surface of the bottom plate of the vacuum-insulated body.

The shelf comprises: a bottom shelf; a side shelf extending upward from an edge of the bottom shelf to form a storage space; a connection member connecting the bottom shelf and the side shelf; and a handle formed on an upper end of the side shelf.

It includes a bottom plate and a side wall extending to one side from the edge of the bottom plate, wherein the bottom plate and the side wall comprises: a vacuum-insulated body that is vacuum-insulated by a vacuum pressure lower than the atmospheric pressure; a wire mesh including a mesh bottom plate being inserted into the vacuum-insulated body, a mesh side plate extending from the edge of the mesh bottom plate to form a storage space in which stones heated to a high temperature are stored, a mesh upper plate being coupled to the mesh side plate, pivoted with respect to the mesh side plate, and disposed to face the mesh bottom plate, and a locking device for locking the mesh upper plate and the mesh side plate; and a lid having the same shape as the opening of the vacuum-insulated body and opening and closing of the opening.

As an embodiment, a vacuum-insulated cooking device includes a bottom plate and a side wall extending to one side from the edge of the bottom plate, wherein the bottom plate and the side wall comprises a vacuum-insulated body that is vacuum-insulated by a vacuum pressure lower than the atmospheric pressure; a shelf being inserted into the vacuum-insulated body and comprising a bottom shelf, a side shelf being disposed above the bottom shelf, a connection shelf connecting the bottom shelf and the side shelf, a cover shelf disposed to face the bottom shelf, a hinge connecting the cover shelf and the side shelf, and a locking device for locking or unlocking the cover shelf and the side shelf; and a lid having the same shape as the opening of the vacuum-insulated body, and opening or closing the opening.

As an embodiment, a vacuum-insulated cooking device includes a bottom plate and a side wall extending to one side from the edge of the bottom plate, wherein the bottom plate and the side wall comprises: a vacuum-insulated body that is vacuum-insulated by a vacuum pressure lower than the atmospheric pressure; a shelf comprising a first wire mesh member inserted into the vacuum-insulated body and having a hemispherical shape, a second wire mesh member being disposed to face the first wire mesh member and having a hemispherical shape, a hinge interconnecting the first and second wire mesh members, and a locking device for locking or unlocking the first and second wire mesh members; and a lid having the same shape as the opening of the vacuum-insulated body, and opening or closing the opening.

Since the vacuum-insulated cooking device according to the present invention does not directly use heat when cooking food, the risk of burns can be reduced, and it has the effect of preventing uneven cooking such as burning or undercooking of meat using a simple cooking method using indirect heat of pre-heated stones and a vacuum-insulated container.

The present invention described below may apply various transformations and may have various embodiments, and specific embodiments are illustrated in the drawings and will be described in detail in the detailed description.

However, it should be understood that this is not intended to limit the present invention to specific embodiments, and includes all transformations, equivalents, and substitutes included in the spirit and scope of the present invention. In describing the present invention, if it is determined that a detailed description of related known technologies may obscure the gist of the present invention, the detailed description will be omitted.

Terms used in this application are only used to describe specific embodiments and are not intended to limit the present invention. Singular expressions include plural expressions unless the context clearly dictates otherwise. In this application, terms such as “comprise” or “have” are intended to designate that the features, numbers, steps, operations, components, parts, or combinations thereof described in the specification exist, and it should be understood that it does not preclude the possibility of the presence or addition of one or more other features, numbers, steps, operations, components, parts, or combinations thereof.

In addition, terms such as first and second may be used to classify and describe various components, but the components should not be limited by the terms. These terms are only used for the purpose of distinguishing one component from another.

In addition, when at least two different embodiments are described in the present application, all or part of the components of each embodiment can be merged and mixed with each other, even if there is no specific description, within the scope of not departing from the technical spirit of the present invention.

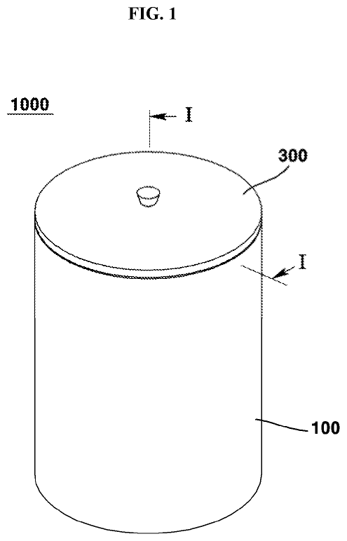

FIG. 1 is an external perspective view of a vacuum-insulated cooking device according to an embodiment of the present invention.

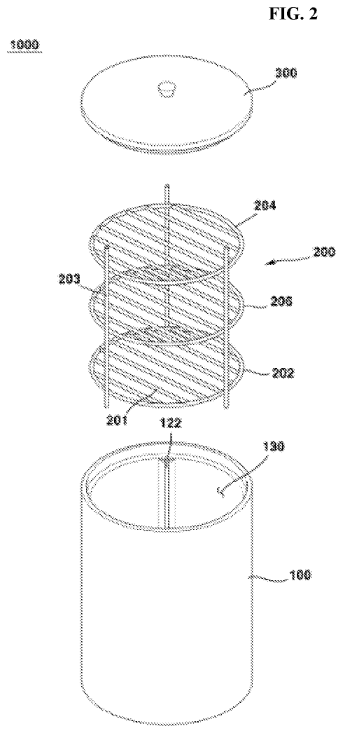

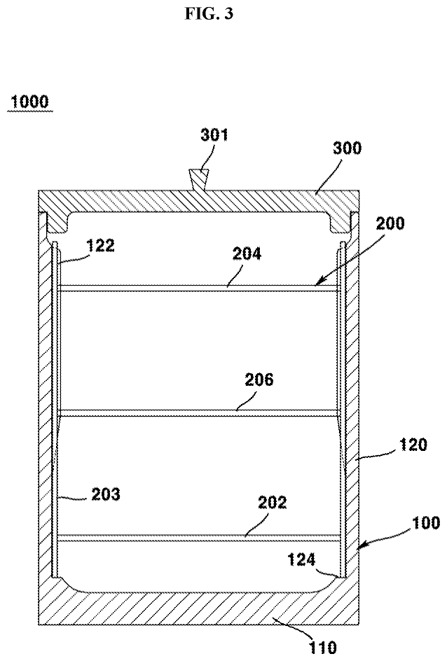

FIG. 2 is an exploded perspective view of a vacuum-insulated cooking device according to an embodiment of the present invention. FIG. 3 is a cross-sectional view taken along the line I-I′ of FIG. 1.

Referring to FIGS. 1 to 3, the vacuum-insulated cooking device 1000 includes a vacuum-insulated body 100, a shelf 200, and a lid 300.

The vacuum-insulated body 100 may be made of, for example, a metal material such as stainless steel, and the vacuum-insulated body 100 is formed to have a cylindrical shape with an open upper portion.

Although in an embodiment of the present invention, the vacuum-insulated body 100 is illustrated and described as having a cylindrical shape, the vacuum-insulated body 100 may be formed into various hollow cylindrical shapes.

The vacuum-insulated body 100 includes a bottom plate 110 and a side wall 120 extending to one side from an edge of the bottom plate 110 to form a storage space 130 therein.

The bottom plate 110 and side wall 120 of the vacuum-insulated body 100 create an empty space inside and a vacuum pressure lower than the atmospheric pressure is formed in the empty space so as to greatly reduce the thermal conductivity, thereby preventing the heat inside the vacuum-insulated body 100 from being transferred to the outside.

The bottom plate 110 formed with vacuum pressure therein is made of a metal material, and the middle portion of an inner side surface of the bottom plate 110 is formed to be concave so that the oil and moisture generated during cooking can be collected.

An alignment groove 122 and a step 124 are formed on an inner side surface of the vacuum-insulated body 100.

The alignment groove 122 is formed in a stripe shape in a direction directing from an upper end of the inner side surface of the side wall 120 toward a lower end of the inner side surface.

The alignment groove 122 is formed in a concave groove shape from an inner side surface of the side wall 120, and unlike this, it is also possible to form an alignment groove 122 by attaching a plate of the same material as the side wall 120 in a portion of the inner side surface of the side wall 120 in a direction directing from an upper end toward a lower end.

In the alignment groove 122, a vertical bar 203 of the shelf 200, which will be described later, is partially disposed so that the shelf 200 can be stably placed at a designated position inside the vacuum-insulated cooking device 1000, and in particular, rotation of the shelf 200 inside the vacuum-insulated body 100 can be prevented.

At least one alignment groove 122 is formed on an inner side surface of the side wall 120, and it may be formed in a number corresponding to the vertical bar 203 of the shelf 200 and at a position corresponding to the vertical bar 203.

For example, when three vertical bars 203 of the shelf 200 are formed, three alignment grooves 122 are formed at positions corresponding to the vertical bars 203 on an inner side surface of the vacuum-insulated body 100,

A step 124 is formed so that the bottom of the shelf 200 can be seated at a lower end of the side wall 120, and the step 124 separates the lower surface of the shelf 200 from the inner side surface of the bottom plate 110.

In this way, when the step 124 is formed in the vacuum-insulated body 100, the lower surface of the bottom plate 110 and the shelf 200 are spaced apart, and materials such as oil or water being generated during food cooking and collected in the bottom plate 110 can be prevented from being in contact with food being cooked.

The shelf 200 may be made of a metal material, and the shelf 200 is formed in a size and shape to be inserted into the storage space 130 formed in the vacuum-insulated body 100, and it is formed in multiple layers to store stones and food materials heated in advance to a high temperature layer by layer in multiple layers.

For example, when the vacuum-insulated body 100 is formed in a cylindrical shape, the shelf 200 includes a disc formed in multiple layers.

The shelf 200 includes, for example, a lower shelf 202, an upper shelf 204, a middle shelf 206, and a vertical bar 203.

A plurality of horizontal bars 201 are formed to be spaced apart from each other in the lower shelf 202 so that stones or food materials can be placed thereon.

The upper shelf 204 is disposed at a position spaced upward from the lower shelf 202, and a plurality of horizontal bars 201 are formed to be spaced apart from each other in the upper shelf 204.

At least one middle shelf 206 is disposed between the upper shelf 204 and the lower shelf 202, and the middle shelf 206 is formed with a plurality of horizontal bars 201 being spaced apart from one another.

In an embodiment of the present invention, the upper shelf 204, the middle shelf 206, and the lower shelf 202 are illustrated and described as being formed by spacing a plurality of horizontal bars 201 apart, but instead of the horizontal bar 201, the upper shelf 204, the middle shelf 206, and the lower shelf 202 may also be formed with a wire mesh having a mesh shape.

Meanwhile, the vertical bar 203 of the shelf 200 interconnects the edges of the upper shelf 204, the middle shelf 206, and the lower shelf 202 to fix the upper shelf 204, the middle shelf 206, and the lower shelf 202 integrally.

In particular, the lower end of the vertical bar 203 extends a certain length toward a lower portion of the lower shelf 202 and is seated in the step 124 formed at the lower end of the side wall 120 so that the inner side surfaces of the shelf 200 and the bottom plate 110 are spaced apart from each other by a predetermined distance.

A plurality of vertical bars 203 may be connected to the upper shelf 204, the middle shelf 206, and the lower shelf 202, and for example, three vertical bars 203 may be formed at intervals of 120 degrees in the shelf 200 formed in a circular shape.

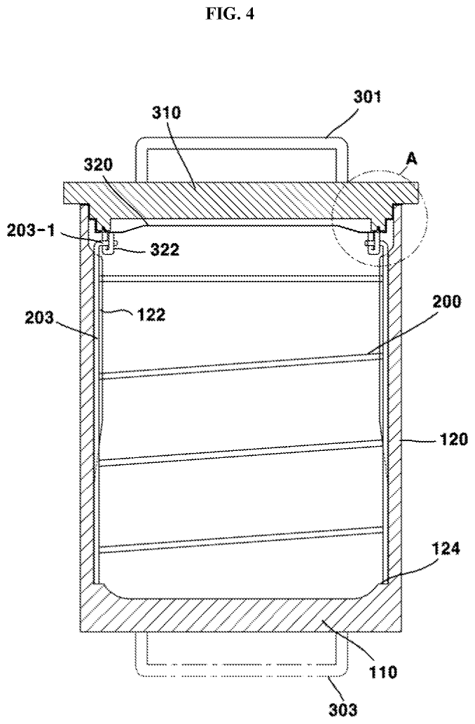

FIG. 4 is a cross-sectional view of a vacuum-insulated cooking device according to another embodiment of the present invention.

Referring to FIG. 4, the vertical bar 203 included in the shelf 200 further includes a hook 203-1.

The hook 203-1 is formed by being extended a certain length from an upper end of the vertical bar 203 to an upper portion of the upper shelf 204.

The hook 203-1 is bent to be caught on a hook 322 formed on a lid 300, which will be described later, and serves to couple or separate the shelf 200 and the lid 300.

The hook 203-1 may be formed in an inverted ‘L’ shape to be suitable for coupling with and separating from the ring 322 being formed in the lid 300, which will be described later.

When the shelf 200 and the lid 300, which will be described later, are connected by the hook 203-1, a user can take out the lid 300 and the shelf 200 at the same time without directly holding the hot shelf 200 after cooking.

Referring back to FIGS. 1 to 3, the lid 300 may be made of a wooden material or a metal material having a vacuum pressure lower than the atmospheric pressure therein and is manufactured in the same shape and size as the open opening of the vacuum-insulated body 100 to be coupled with or separated from the opening of the vacuum-insulated body 100.

When the lid 300 is made of wooden materials and the like, the lid 300 can be used as a cutting board for cooking food and the like.

When the vacuum-insulated body 100 and the lid 300 are firmly coupled, the storage space 130 formed inside the vacuum-insulated body 100 becomes vacuum-insulated so that when food is cooked in the storage space 130 of the vacuum-insulated body 100, it is possible to minimize heat being discharged from heated stones or the like to the outside, and after cooking, the lid 300 is separated from the vacuum-insulated body 100 so that the shelf 200 or food materials stored therein can be taken out through the opening.

A handle 301 is formed on an upper surface of the lid 300 in a shape and size that a user can hold by hand when opening and closing of the lid 300.

In an embodiment of the present invention, the handle 301 is illustrated and described as integrally formed of the same material as lid 300, but unlike this, the handle 301 may be made of a material different from that of the lid 300 and then coupled to the lid 300.

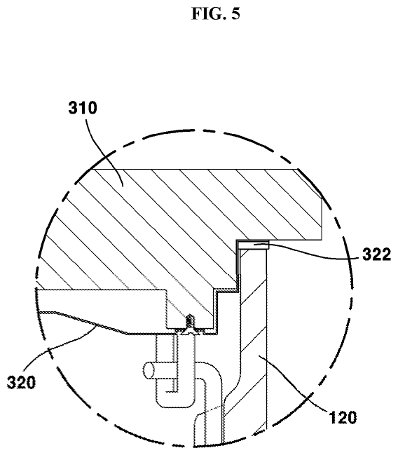

FIG. 5 is an enlarged view of part ‘A’ of FIG. 4.

Referring to FIGS. 4 and 5, the lid 300 may include a first lid 310 and a second lid 320.

The first lid 310 is made of a wooden material and is formed in a shape being coupled to an open opening of the vacuum-insulated body 100.

The second lid 320 is made of a metal material, for example, stainless steel, and is manufactured in a shape being coupled to an inner side surface of the first lid 310 so that it is tightly coupled to the inner side surface of the first lid 310 in various ways such as a forced fitting method or a screw-coupling.

When the second lid 320 is coupled to the first lid 310, since the first lid 310 made of wood is not directly exposed to moisture such as steam generated during cooking, the first lid 310 can be prevented from being contaminated or deformed.

The second lid 320 is fit-coupled with the side wall 120 after being coupled to the first lid 310 and the central portion of the second lid 320 is formed to be concave.

In an embodiment of the invention, the central portion of the second lid 320 is formed to be concave so that if necessary, a user may dispose the first and second lids 310 and 320 of the vacuum-insulated cooking device 1000 on the bottom, and when using the side wall 120 by lifting it, the lids can serve as an oil pan to make sure that the foreign substances such as oil generated during cooking do not leak out of the container and gather in the concave portion.

The second lid 320 includes a ring 322, and a plurality of rings 322 are formed on an outer side surface of the second lid 320 at a position corresponding to the previously described hook 203-1, and the rings 322 are coupled to or separated from the hook 203-1.

The ring 322 may be formed in a ‘U’ shape so that the hook 203-1 having an inverted ‘L’ shape can be coupled and seated.

In an embodiment of the present invention, the second lid 320 may further include a discharge outlet 324.

The discharge outlet 324 is formed with a groove in a portion of the second lid 320 where the second lid 320 and the side wall 120 are in contact with each other, and discharges the steam being generated inside the vacuum-insulated body 100 during food cooking to the outside.

In an embodiment of the present invention, as illustrated in FIG. 4, it is illustrated that the handle 301 is formed on the lid 300, but unlike this, without forming the handle 301 on the lid 300, another handle 303 may be formed on the outer side surface of the bottom plate 110 of the vacuum-insulated cooking body 100.

In this way, when the handle 303 is formed on an outer side surface of the bottom plate 110 of the vacuum-insulated cooking body 100, a user may use the lid 300 as a support base and more easily take out the food to the outside by lifting the vacuum-insulated cooking body 100 upside down using the handle 303.

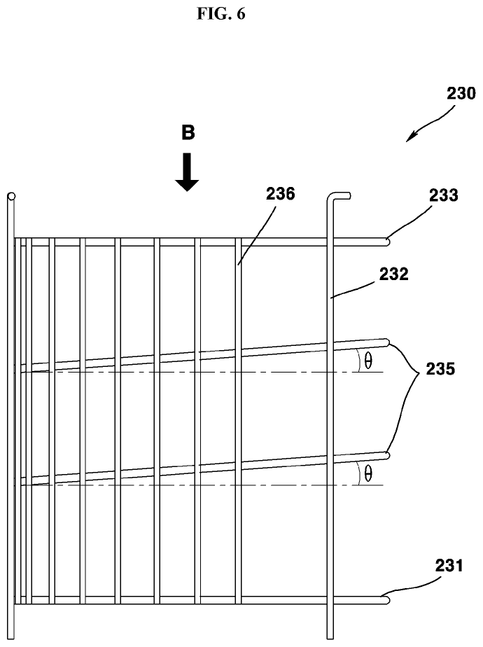

Hereinafter, embodiments of various shelves used in the vacuum-insulated cooking device 1000 will be described with reference to FIGS. 6 to 11.

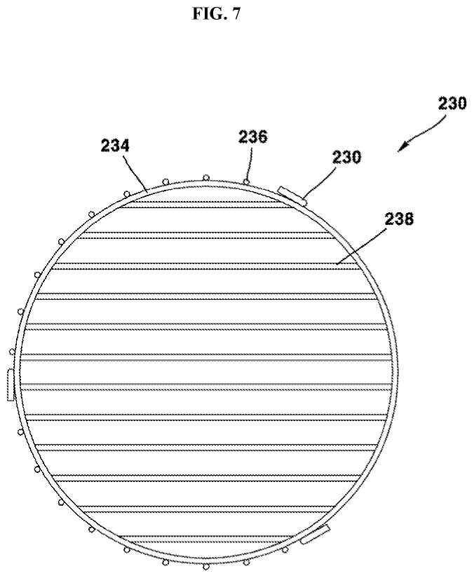

FIG. 6 is a cross-sectional view illustrating a shelf according to another embodiment of the present invention; and FIG. 7 is a front view seen from the ‘B’ direction of FIG. 6.

Referring to FIGS. 6 and 7, the shelf 230 includes a lower shelf 231, an upper shelf 233, a middle shelf 235, and a vertical bar 232 interconnecting them.

The lower shelf 231, the upper shelf 233, and the middle shelf 235 are comprised of a circular edge 234 and a plurality of horizontal bars 238 coupled to the circular edge 234, respectively.

The lower shelf 231 and the upper shelf 233 are disposed parallel to each other, while the middle shelf 235 is inclinedly disposed at a predetermined angle θ with respect to the lower shelf 231.

When the middle shelf 235 is inclinedly disposed at a certain angle θ with respect to the lower shelf 231 and the upper shelf 233, oil or moisture being generated during cooking is discharged and stones or food materials are prevented from being separated from the shelf 230.

In an embodiment of the present invention, the shelf 230 may further include a wire mesh 236 to prevent stones or food materials disposed on the lower shelf 231, the upper shelf 233, and the middle shelf 235 from falling.

The wire mesh 236 is formed only on a portion of the side surface of the shelf 230 so as not interfere with the storing and discharging of stones or food materials to and from the shelf 230. For example, an opening may be formed by forming the wire mesh 236 only on two third of the side surface of the shelf formed in a circular shape and not forming the wire mesh 236 on the other portion.

Meanwhile, the direction of the horizontal bar 238 is formed parallel to the opening direction of the wire mesh 236, and this is to make it easy to insert and remove without being caught on the horizontal bar 238 loaded with a large number of stones or food materials when adding or removing stones or food materials.

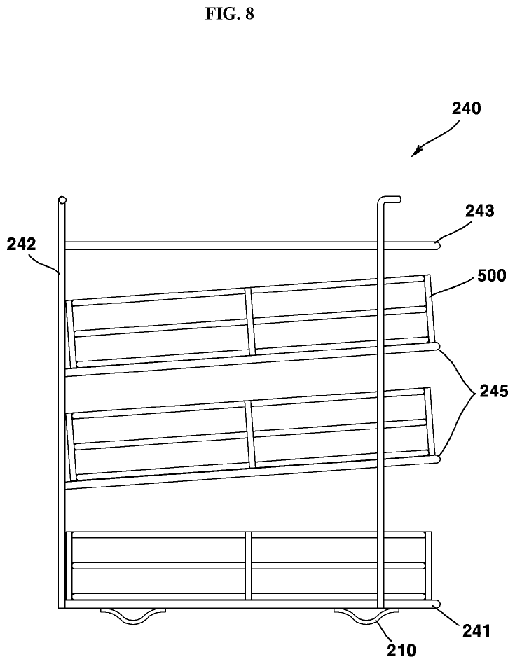

FIG. 8 is a cross-sectional view illustrating a metal storage container mounted on a shelf according to yet another embodiment of the present invention.

Referring to FIG. 8, the vacuum-insulated cooking device 1000 may further include a metal storage container 400 being detachably coupled to the shelf 240.

The metal storage container 400 is made of a metal material, having a space capable of disposing stones or food materials therein, and formed in a form that can be detachably coupled between the lower shelf 241 and the middle shelf 245, and between the middle shelf 245 and the upper shelf 243.

The vertical bar 242 interconnecting the edges of the upper shelf 204, the middle shelf 206, and the lower shelf 202 is formed at a position that does not interfere with the metal storage container 400 during insertion or removal thereof.

When using a metal storage container 400, a user can divide and dispose stones or food materials in the metal storage container 400 so that they can be put into or taken out of the shelf 240, thereby making cooking simple and convenient.

Meanwhile, a support 210 may be further included on a lower surface of the lower shelf 241 to separate the inner side surface of the bottom plate 110 from the shelf 240.

When the support 210 is formed, even in a vacuum-insulated cooking device 1000 in which the step 124 is not formed separately, the bottom plate 110 and the bottom surface of the shelf 200 are spaced apart, so that oil or water and the like being generated during food cooking and gathered toward the bottom plate 110 can be prevented from being in contact with food being cooked.

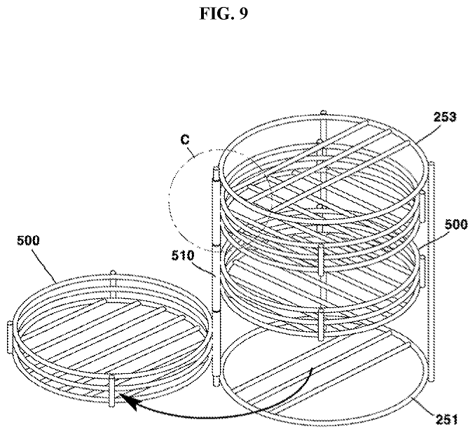

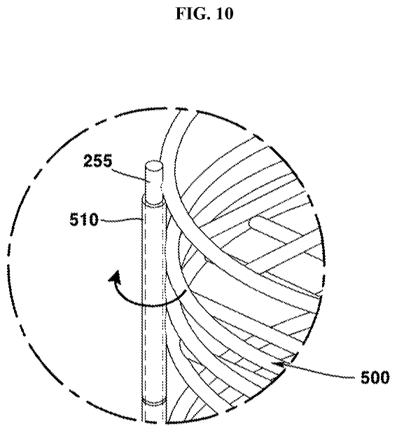

FIG. 9 is a perspective view illustrating a shelf according to yet another embodiment of the present invention; and FIG. 10 is an enlarged view of part ‘C’ of FIG. 9.

Referring to FIGS. 9 and 10, the metal storage container 500 may further include a pivoting member 510.

The pivoting member 510 has a pipe shape being formed with a hollow, the outer side surface of the pivoting member 510 is coupled to a side surface of the metal storage container 500, and a vertical bar 255 of the shelf 250 is inserted through the hollow of the pivoting member 510.

By the pivoting member 510, the metal storage container 500 rotates the vertical bar 255 coupled with the pivoting member 510 with respect to the shelf 250 as a rotation axis, and through this, it is possible to easily insert and remove stones and food materials from the metal storage container 400.

At this time, the pivoting member 510 is formed longer than the height of the metal storage container 500, so that it is possible to prevent them from being caught with each other when the plurality of metal storage containers 500 disposed in an up and down direction is rotated.

Meanwhile, in order to prevent the metal storage container 500 from rotating in an undesirable direction, an iron core or wire mesh is formed on a portion of the side of the shelf 250 to prevent the metal storage container 500 from being rotated in an undesirable direction.

In addition, in order to prevent the metal storage container 500 from being unintentionally rotated and removed from the shelf 250, a fixing device (not shown) that can fix the metal storage container 500 and the shelf 250 may be further included.

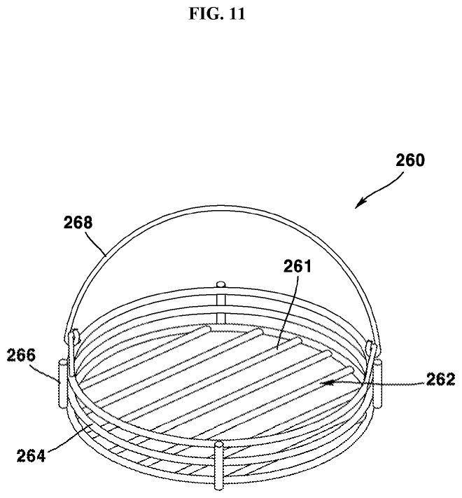

FIG. 11 is a perspective view illustrating a shelf according to yet another embodiment of the present invention.

Referring to FIG. 11, the shelf 260 may be applied to the vacuum-insulated cooking device 1000 illustrated in FIG. 1.

The shelf 260 comprises a bottom shelf 262, a side shelf 264, and a connection member 266.

The bottom shelf 262 forms a bottom on which stones or food materials are placed. For example, a plurality of horizontal bars 261 may be formed spaced apart by a predetermined interval, and unlike this, it may also be manufactured by forming grooves at regular intervals in a plate material.

The side shelf 264 is formed by being extended upward from the edge of the bottom shelf 262.

The connection member 2266 connects the bottom shelf 262 and the side shelf 264.

The bottom shelf 262 and the side shelf 264 are connected by the connection member 266 to form a certain storage space, and stones or food materials, and the like are placed in the storage space.

In addition, a handle 268 is further included at an upper end of the side shelf 264 so that a user can hold, lift, or transport the shelf 260.

The handle 268 is made of the same material as the shelf 260, and is pivotally coupled to an upper end of the side shelf 264, and the handle 268 is pivoted in a direction perpendicular to the shelf in the case when lifting or carrying the shelf 260 so that it can be carried by holding the handle 268 by hand, and when storing or cooking, the handle 268 may be fixed by closely contacting it with an outer circumferential surface of the upper portion of the shelf 260.

The shelf 260 formed according to an embodiment of the present invention can be used in multi-layered form by sequentially storing a plurality of them layer by layer in the storage space 130 of the vacuum-insulated cooking device 1000, and by forming the shelf 260 individually, only the desired shelf 260 can be selectively put in or taken out from the vacuum-insulated cooking device 1000 as necessary.

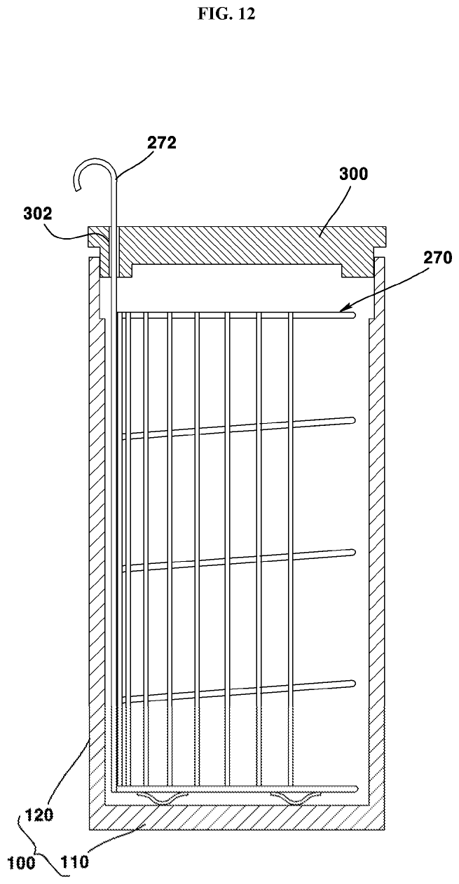

FIG. 12 is a cross-sectional view of a vacuum-insulated cooking device according to another embodiment of the present invention. The vacuum-insulated cooking device illustrated in FIG. 12 has substantially the same configuration as the vacuum-insulated cooking device illustrated and described in FIGS. 1 to 5 except for the vertical bar 272 and the escape hole 302. Therefore, overlapping description of the same configurations will be omitted, and the same names and the same reference numerals will be given to the same configurations.

Referring to FIG. 12, an end portion of the vertical bar 272 of the vacuum-insulated cooking device 1000 is extended to the outside of the lid 300.

The end portion of the vertical bar 272 exposed by being extended outward may be manufactured in a shape that a user can hold, and for example, the protruded portion of the vertical bar 272 may be bent and used as a handle.

In a portion of the outer side of the lid 300, an escape hole 302 through which the extended vertical bar 272 can penetrate is further included.

The escape hole 302 is manufactured in a shape through which a portion of the vertical bar 272 can pass, and the vertical bar 272 being extended to the outside of the lid 300 through the escape hole 302 and the lid 300 can be coupled and separated without interference.

Meanwhile, the escape hole 302 may simultaneously serve to discharge steam generated inside the vacuum-insulated body, and in this case, it is not necessary to separately form a discharge outlet 324 of the lid 300.

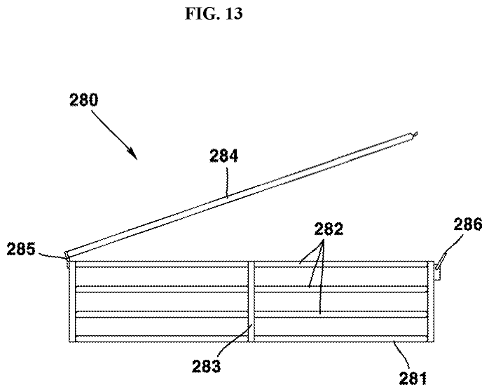

FIG. 13 is a view illustrating a shelf according to another embodiment used in a vacuum-insulated cooking device according to another embodiment of the present invention.

Referring to FIG. 13, the shelf 280 may be stored inside the vacuum-insulated cooking device 1000 illustrated in FIG. 1.

The shelf 280 comprises a bottom shelf 281, a side shelf 282, a connection member 283, a cover shelf 284, a hinge 285, and a locking device 286.

The bottom shelf 281 forms a bottom on which stones or food materials are placed, and for example, a plurality of horizontal bars may be spaced apart from each other by a predetermined interval to support stones or food materials.

A plurality of side shelves 282 are formed so as to be extended upward from the edge of the bottom shelf 281.

The connection member 283 interconnects the bottom shelf 281 and the side shelf 282.

The cover shelf 284 is formed in the same shape and size as the bottom shelf 281, and prevents stones or food stored in the bottom shelf 281 and the side shelf 282 from being separated to the outside.

The hinge 285 connects the upper ends of the cover shelf 284 and the side shelf 282, so that the cover shelf 284 pivots from the side shelf 282, and due to this, a user can quickly and easily store stones or food on the bottom shelf 281 and the side shelf 282.

The locking device 286 prevents the cover shelf 284 from being arbitrarily opened from the side shelf 282, and at least two locking devices 286 may be formed in the cover shelf 284 or the side shelf 282 for safety. The locking device 286 may include, for example, a latch or the like.

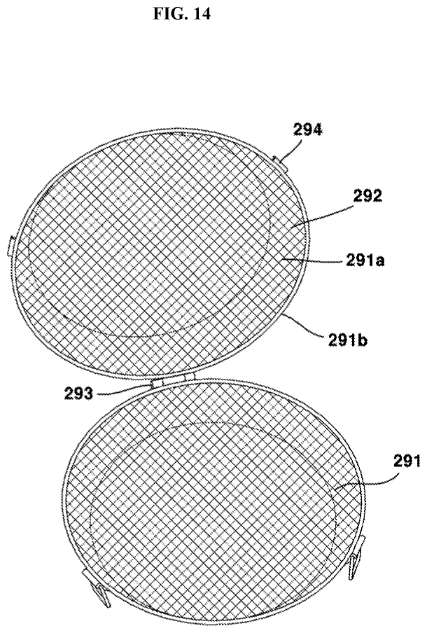

FIG. 14 is a view illustrating a shelf according to another embodiment used in a vacuum-insulated cooking device according to another embodiment of the present invention.

Referring to FIG. 14, the shelf 290 may be applied to the vacuum-insulated cooking device 1000 illustrated in FIG. 1.

The shelf 290 comprises a first wire mesh member 291, a second wire mesh member 292, a hinge 293, and a locking device 294.

The first wire mesh member 291 includes a first wire mesh 291a being formed in a hemispherical shape and a first steel wire 291b being connected to an edge of the first wire mesh 291a.

The second wire mesh member 292 includes a second wire mesh 292a being formed in a hemispherical shape and a second wire 292b being connected to an edge of the second wire mesh 292a.

The first wire mesh member 291 and the second wire mesh member 292 are disposed to form a storage space when the first and second wire meshes 291a and 292a are being overlapped with each other.

The hinge 293 is coupled to the edges of the first wire mesh member 291 and the second wire mesh member 292, so that the first and second wire mesh members 291 and 292 can be widened from each other.

In a state where stones or food are inserted between the first and second wire mesh members 291 and 292, the locking device 294 prevents spilling out of stones or food to the out as the first and second wire mesh members 291 and 292 are arbitrarily opened, and a variety of well-known structures may be used for the locking device 294, and at least two locking devices 294 may be applied to the first and second wire mesh members 291 and 292.

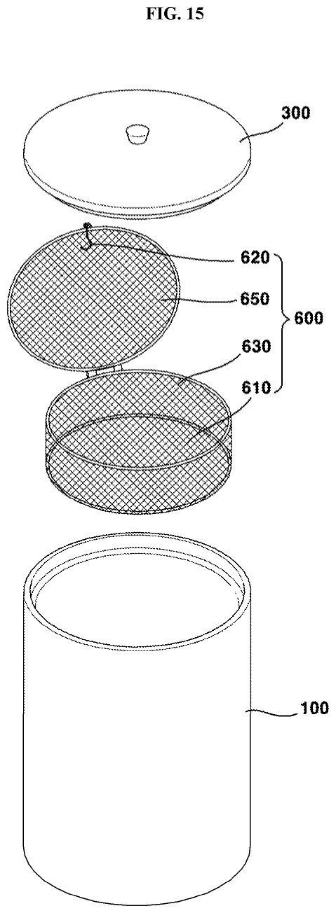

FIG. 15 is a perspective view illustrating a vacuum-insulated cooking device according to yet another embodiment of the present invention. The vacuum-insulated cooking device illustrated in FIG. 15 has substantially the same configuration as the vacuum-insulated cooking device illustrated and described in FIG. 1 except for a wire mesh that stores stones heated to a high temperature. Therefore, overlapping description of the same configuration will be omitted, and the same name and the same reference numerals will be assigned to the same technical configuration.

Referring to FIG. 15, a wire mesh 600 having a mesh shape is used so that a user can more easily insert stones heated to a high temperature into the vacuum-insulated body 100.

The wire mesh 600 is formed of a mesh bottom plate 610, a mesh side plate 630, a mesh upper plate 650; a locking device 620, and the mesh bottom plate 610 is formed in a circular shape being inserted into the vacuum-insulated body 100; the mesh side plate 630 is extended from the edge of the mesh bottom plate 610 to a predetermined height; and as a result, a space for storing stones and the like is formed by the mesh side plate 630 and the mesh bottom plate 610.

Meanwhile, in order to more easily insert stones into the storage space formed by the mesh side plate 630 and the mesh bottom plate 610 and prevent the stones from escaping, a mesh upper plate 650 formed identically to the mesh bottom plate 610 is connected to the mesh side plate 630, and a locking device 620 for locking the mesh upper plate 650 to the mesh side plate 630 is coupled to the mesh upper plate 650.

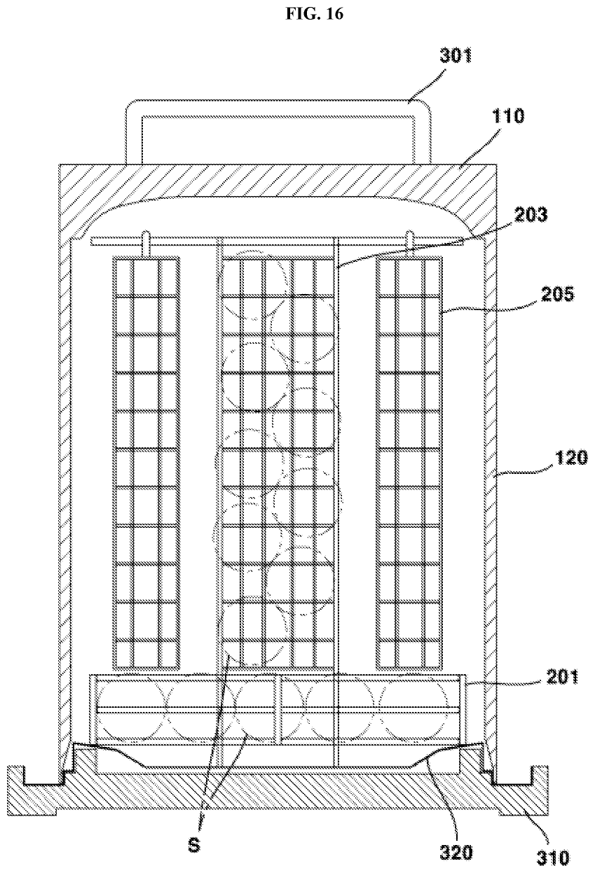

FIG. 16 is a cross-sectional view illustrating a vacuum-insulated cooking device according to yet another embodiment of the present invention. The vacuum-insulated cooking device illustrated in FIG. 16 has substantially the same configuration as the vacuum-insulated cooking device illustrated and described in FIG. 1 except for the shelf 220 and the bottom plate 110. Therefore, overlapping description of the same configuration will be omitted, and the same name and the same reference numerals will be assigned to the same technical configuration.

Referring to FIG. 16, the shelf 220 of the vacuum-insulated cooking device 1000 comprises a first stone storage shelf 221, a second stone storage shelf 223, and a food storage shelf 225.

The first stone storage shelf 221 is formed in a shape capable of storing stones S heated in a disc shape, and may have, for example, a shape similar to the metal storage container 400 according to an embodiment of the present invention.

The second stone storage shelf 223 is formed by being erected in a cylindrical shape in the central portion of the first stone storage shelf 221, and, for example, a portion of a plurality of vertically erected vertical bars is wrapped with wire mesh or a bar and the like to form a storage space therein, and the stones S being heated are stored in the storage space.

At least one or more of horizontal bar may be formed on an upper portion of the second stone storage shelf 223 in a horizontal direction.

A food storage shelf 225, which will be described later, is suspended on the horizontal bar.

The lower portion and side surface of the food storage shelf 225 is formed of a plurality of bars spaced apart at regular intervals or formed of wire mesh in various shapes such as cylinders and rectangular parallelepipeds having a storage space of a certain size therein, and an opening is formed on one surface of the food storage shelf 225 to store food in the storage space or to discharge food after cooking.

In addition, a ring 225a is formed at an upper portion of the food storage shelf 225 so that the food storage shelf 225 can be hung on a horizontal bar formed at an upper portion of the second stone storage shelf 223.

In an embodiment of the present invention, when used as the first stone storage shelf 221, the second stone storage shelf 223, and the food storage shelf 225, due to the weight of stones and food materials stored on each shelf 220, a difficult problem occurs in taking the shelf 220 out of the vacuum-insulated cooking device 1000 after cooking is completed.

In order to solve this problem, in an embodiment of the present invention, a lid 300 is disposed at a lower side to serve as a support base, and the vacuum-insulated body 100 is placed at an upper side to be served as a lid, and on an outer side surface of the bottom plate 110 of the vacuum-insulated body 100, a handle 303 that can be gripped by a user and folded in a vertical or horizontal state with respect to the bottom plate 110 may be further included.

In an embodiment of the present invention, when the lid 300 is disposed at a lower side to serve as a support base, the handle 303 can be used in a vertical state with respect to the bottom plate 110, and conversely, when the bottom plate 110 is disposed at a lower side to be served as a support base, the handle 3030 can be folded and stored in a state horizontal to the bottom plate 110. To this end, a groove (not shown) in which the handle 303 can be folded and stored may be formed on an outer side surface of the bottom plate 110.

In this way, when the handle 303 is formed on an outer side surface of the bottom plate 110 of the vacuum-insulated cooking body 100, food can be more easily discharged to the outside by always lifting only a certain weight, that is, the weight of the vacuum-insulated body 100 regardless of the weight of stones S and food materials stored on the shelf 220 inside the vacuum-insulated body 100.

In addition, since the upper portion is blocked by the vacuum-insulated body 100, the internal thermal energy can be managed more efficiently.

Meanwhile, since the middle portion of an inner side surface of the lid 300 is concave, even if the lid 300 is used to serve as a support base, oil and moisture being generated during cooking do not leak out of the vacuum-insulated cooking device 1000 and can be accumulated in the concave portion in the middle of the inner side surface of the lid 300.

As described in detail above, the present invention can reduce the risk of burns since it does not directly use heat during food cooking, and it has an effect of preventing uneven cooking such as burning or undercooking of meat by using a simple cooking method using indirect heat of preheated stones and a vacuum-insulated container.

Meanwhile, embodiments disclosed in this drawing are only presented as specific examples to aid understanding and are not intended to limit the scope of the present invention. It is obvious to those skilled in the art that other modifications based on the technical spirit of the present invention can be implemented in addition to the embodiments disclosed herein.

The present invention can be used for a vacuum-insulated cooking device that prevents food from burning and can keep warm at a constant temperature.

What is claimed is:

1. A vacuum-insulated cooking device comprising:
a vacuum-insulated body including a bottom plate and a sidewall extending from an edge of the bottom plate to one side, wherein the bottom plate and the sidewall are vacuum-insulated by a vacuum pressure lower than the atmospheric pressure;
a shelf which is accommodated in a storage space formed by the bottom plate and the side wall and on which stones and food materials heated to a high temperature from the outside are stored layer by layer; and
a lid, having the same shape as an opening of the vacuum-insulated body, for opening and closing of the opening.

2. The vacuum-insulated cooking device according to claim 1,
wherein an alignment groove is formed on an inner side surface of a side wall of the vacuum-insulated body to align the shelf to a designated position in a direction directing from an upper end to a lower end of the side wall, a lower surface of the shelf is formed at a lower end of the side wall, and a step separating the lower surface of the shelf from an inner side surface of the bottom plate is formed at a lower end of the side wall.

3. The vacuum-insulated cooking device according to claim 1,
wherein the lid is made of a metal material, a vacuum pressure lower than the atmospheric pressure is formed inside, and a handle is formed on an upper surface thereof.

4. The vacuum-insulated cooking device according to claim 1,
wherein the lid comprises:
a first lid formed of a wooden material and formed in a shape being coupled to the opening and a second lid made of metal and coupled to an inner side surface of the first lid, being fit-coupled into the side wall, and being formed concavely in a middle portion,
wherein a plurality of rings are formed at equal intervals on an outer side surface of the second lid, and
wherein hooks being detachably coupled to each of the rings are formed in the shelf.

5. The vacuum-insulated cooking device according to claim 4,
wherein a handle is formed in the first lid, and a discharge outlet for discharging steam generated inside the vacuum-insulated body is formed at a portion of the second lid being in contact with the side wall.

6. The vacuum-insulated cooking device according to claim 1,
wherein the shelf comprises, a lower shelf being formed to have a size being inserted into the vacuum-insulated body and having a plurality of horizontal bars, an upper shelf being spaced upward from the lower shelf and having the horizontal bars formed therein, a middle shelf, at least one is disposed between the upper shelf and the lower shelf and formed with the horizontal bars therein, a vertical bar interconnecting the upper shelf, the middle shelf and the lower shelf, and a hook extending from the vertical bar to an upper portion of the upper shelf, and
wherein the lower shelf and the upper shelf are disposed parallel to each other, and the middle shelf is inclinedly disposed with respect to the lower shelf.

7. The vacuum-insulated cooking device according to claim 6,
wherein the lower shelf, the upper shelf, and the middle shelf are formed in a circular shape,
wherein a wire mesh is formed on a portion of a side surface of the shelf to prevent stones or food materials from falling from the lower shelf, the upper shelf, and the middle shelf, and
wherein the direction of the horizontal bar is formed to be parallel to the opening direction of the wire mesh.

8. The vacuum-insulated cooking device according to claim 6,
wherein a metal storage container capable of storing stones or food is detachably coupled between the lower shelf and the middle shelf, and between the middle shelf and the upper shelf, respectively.

9. The vacuum-insulated cooking device according to claim 8,
wherein a pivoting member having a pipe shape is coupled to a side surface of the metal storage container, and the pivoting member is pivotally coupled to the vertical bar.

10. The vacuum-insulated cooking device according to claim 6,
wherein an end portion of the vertical bar is extended to the outside of the lid, and an escape hole is formed in the lid to allow the vertical bar to pass through.

11. The vacuum-insulated cooking device according to claim 1,
wherein the shelf comprises, a first stone storage shelf that stores stones in a disc shape and being heated, a second stone storage shelf that is formed in a cylindrical shape at a central portion of the first stone storage shelf and stores stones being heated, a food storage shelf in which food is stored by being inserted into a bar extending horizontally from an upper end of the second stone storage shelf and being disposed in an erected state around the second stone storage shelf, and a handle formed on an outer side surface of the bottom plate of the vacuum-insulated body.

12. The vacuum-insulated cooking device according to claim 1,
wherein the shelf comprises a bottom shelf, a side shelf extending upward from an edge of the bottom shelf to form a storage space, a connection member connecting the bottom shelf and the side shelf, and a handle formed on an upper end of the side shelf.

13. A vacuum-insulated cooking device comprising:
a vacuum-insulated cooking device including a bottom plate and a side wall extending to one side from the edge of the bottom plate, wherein the bottom plate and the side wall comprises a vacuum-insulated body that is vacuum-insulated by a vacuum pressure lower than the atmospheric pressure;
a shelf being inserted into the vacuum-insulated body and comprising a bottom shelf, a side shelf being disposed above the bottom shelf, a connection shelf connecting the bottom shelf and the side shelf, a cover shelf disposed to face the bottom shelf, a hinge connecting the cover shelf and the side shelf, and a locking device for locking or unlocking the cover shelf and the side shelf; and
a lid having the same shape as the opening of the vacuum-insulated body, and opening or closing of the opening.

14. A vacuum-insulated cooking device comprising:
a vacuum-insulated cooking device including a bottom plate and a side wall extending to one side from the edge of the bottom plate, wherein the bottom plate and the side wall comprises a vacuum-insulated body that is vacuum-insulated by a vacuum pressure lower than the atmospheric pressure;
a shelf comprising a first wire mesh member inserted into the vacuum-insulated body and having a hemispherical shape, a second wire mesh member being disposed to face the first wire mesh member and having a hemispherical shape, a hinge interconnecting the first and second wire mesh members, and a locking device for locking or unlocking the first and second wire mesh members; and
a lid having the same shape as the opening of the vacuum-insulated body, and opening or closing of the opening.
